(19) United States
(12) Patent Application Publication
(10) Pub. No.: US 2004/0117322 A1
(43) Pub. Date: Jun. 17, 2004

(54) System, method and computer program product for providing profile information

(75) Inventors: Margareta Bjorksten, Helsinki (FI); Mitri Abou-Rizk, Newton, MA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 10/322,066

(22) Filed: Dec. 17, 2002

(51) Int. Cl. G06F 17/60

(52) U.S. Cl. 705/80

(57) ABSTRACT

A system for providing profile information includes a user device and a profile broker. The user device can receive a request for profile information in a selected format from a second party. In turn, the profile broker can determine if the second party can access the profile information. If the second party does not have access, the profile broker can enter into an agreement to thereby grant access to the second party. In this regard, the profile broker can enter into the agreement by forwarding a contract to the second party and thereafter receiving from the second party an indication of agreement to the contract. Advantageously, the contract specifies at least an allowable use of the profile information. If the second party has access, or has otherwise been granted access, the profile broker can transfer the profile information to the second party in the selected format.

### FIELD OF THE INVENTION

The present invention generally relates to systems, methods and computer program products for providing profile information and, more particularly, relates to systems, methods and computer program products for providing limited access, through contracts, to profile information in a predefined format.

### BACKGROUND OF THE INVENTION

As companies realized that access to personal data is a powerful tool to improve service and product offerings, on-line collections of personal data have been increasing rapidly. The ability to better match consumers' needs and desires makes a company more efficient and reduces advertising costs while increasing customer loyalty. Research Shows consumers are willing to provide personal information in order to receive better or less expensive services. However, because misuse of personal data is increasing, consumers are becoming more and more reluctant to give out their personal information/data.

Users currently have little or no control over profiles containing data relating to them and have limited means to express their requirements or limitations related to the use of personal information about them. For example, information about a user, including the user's email address, may be sold or distributed without consulting with the user, thereby making the user more susceptible to identity theft, spam and other misuse of their personal data. Thus, the user has no control over what information he or she receives.

Further, it is often very difficult for the user to correct false information about the user contained in profiles maintained by others, i.e., second parties. In this regard, of the second parties that use a user's personal information, a multitude of personal profiles for the user are typically created and stored with the various second parties. A number of services, such as Microsoft's PASSPORT™ service, are currently being developed and implemented to allow users to create more generalized personal profiles that can be utilized by a plurality of second parties. Whereas such services give users a small amount of control over what information is stored in the personal profile, such services have drawbacks. Among the drawbacks, such services typically do not provide users with adequate control over the use of the personal information in the user's personal profile after the information has been disseminated.

Further, different services typically store the personal profiles in different formats that are not compatible with all of the devices of second parties that use such services. As such, different services may include a personal profile of a single user in different formats. Because of the number of personal profiles of a single user, however, it remains difficult for the user to correct or otherwise alter information about the user in all of the personal profiles of such services.

### SUMMARY OF THE INVENTION

In light of the foregoing background, the present invention provides an improved system, method and computer program product for providing profile information. According to embodiments of the present invention, the system, method and computer program product provide a user with control over who receives personal information pertaining to the user by providing the user with control over how profile information about the user may be collected, accessed, used and distributed by others, such as second parties. The system, method and computer program product of embodiments of the present invention provide the user with control over the profile information by predicating the user's release of the information upon the user and second party reaching an agreement, embodied in a contract. In this regard, the contract can specify, for example, access and use, by the second party, of one or more selected portions of the personal information. Further, to facilitate use of the profile information by the second party, the system, method and computer program product of embodiments of the present invention can format the accessed profile information in a format specified by the second party, such as a format capable of being stored and utilized by a second party device operated by the second party.

According to one aspect of the present invention, a system is disclosed for providing profile information. The system includes a user device capable of receiving a request for profile information from a second party, where the request includes a selected format. The system also includes a profile broker in communication with the user device. The profile broker is capable of determining whether the second party has access to the profile information. If the second party does not have access, the profile broker can then enter into an agreement to thereby grant access to the second party. In this regard, the profile broker can enter into the agreement by forwarding a contract to the second party and thereafter receiving from the second party an indication of agreement to the contract. The contract can be provided by a contract broker capable of providing at least one contract to a user of the user device. Advantageously, the contract specifies at least an allowable use of the profile information and, as such, allows the user to exert control over use of the user's private information. If the second party has access, or has otherwise been granted access, the profile broker can transfer the profile information to the second party in the selected format.

The profile broker can include a rules enforcer and an agreement facilitator. In addition, the profile broker can include a history recorder capable of recording a history of actions performed by the profile broker and/or agreements entered into by the profile broker. The rules enforcer can determine whether the second party has access to the profile information. If the second party does not have access, such as by not being party to an agreement with the user regarding access to the profile information, the agreement facilitator can enter into an agreement to thereby grant access to the second party, such as by negotiating an agreement and thereafter entering into the agreement. More particularly, the agreement facilitator is capable of forwarding a contract to the second party and thereafter receiving from the second party an indication of agreement to the contract, provided an agreement is reached. In this regard, the contract can specify at least an allowable use of the profile information.

The user device can be capable of receiving an indication of which portions of personal data stored in a personal data repository are releasable to the second party. Then, the profile information can include those portions that are releasable to the second party. In one embodiment, the user device is further capable of defining a service profile that includes the profile information and at least one allowable use of the profile information by the second party. The service profile can also include a date and a time at which at least a portion of the profile information within the service profile was transferred to the second party, and further identifies the second party to whom the stored information was transferred. In addition, the service profile can also include a description of the contract.

The user device can also include storage capable of storing the profile information. Alternatively, the system can include a trusted party device having storage capable of storing the profile information. In yet another alternative, a portion of the profile information can be stored in storage of the user device, while the remaining portion of-the profile information is stored in storage of the trusted party device.

The system can also include a mapping module in communication with the profile broker. The mapping module can be capable of receiving the profile information in a predefined format, and thereafter reformatting the profile information into the selected format when the predefined format differs from the selected format. In one embodiment, the profile broker and the mapping module are embodied within the user device. In another embodiment, however, the profile broker and the mapping module are included within the trusted party device.

In one embodiment, the user device is capable of receiving a request and thereafter transmitting a redirect request to the second party. In this embodiment, the system further comprises a trusted party device that includes the profile broker. In this regard, the trusted party device can receive a redirected request from the second party such that the profile broker can, as before, determine whether the second party has access to the profile information, enter into the agreement and transfer the profile information. Further, the trusted party device can include a mapping module in communication with the profile broker. As such, the mapping module can receive the profile information in a predefined format, and thereafter reformat the profile information into the selected format when the predefined format differs from the selected format.

According to another aspect of the present invention, a method and computer program product are provided for providing profile information. Therefore, embodiments of the present invention provide an improved system, method and computer program product for providing profile information. The system, method and computer program product of embodiments of the present invention provide users with control over dissemination and use of personal information. In this regard, second parties who request such personal information are required to agree to a contract that specifies, for example, access and use, by the second party, of any portions of the personal information. Further, the system, method and computer program product of embodiments of the present invention facilitate use of the profile information by the second party by providing the accessed personal information in a format specified by the second party, such as a format capable of being stored and utilized by a second party device operated by the second party. As such, the system, method and computer program product of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a block diagram of a system for providing profile information according to one embodiment of the present invention;

FIG. 2 illustrates an example of a personal data repository having a master profile and one or more service profiles according to one embodiment of the present invention;

FIGS. 3A and 3B are functional block diagrams illustrating a trusted party device according to embodiments of the present invention;

FIGS. 4A-4C are functional block diagrams illustrating a user device according to embodiments of the present invention;

FIG. 5 is a functional block diagram of a profile broker according to one embodiment of the present invention;

FIG. 6 is a functional block diagram of a mapping module according to one embodiment of the present invention;

FIGS. 7A-7E are control flow diagrams illustrating a method of providing profile information according to various embodiments of the present invention;

FIG. 8 is an illustration of an exemplar contract between a user and a second party according to one embodiment of the present invention;

FIG. 9 is a flow chart illustrating operation of a rules enforcer of a profile broker according to one embodiment of the present invention; and

FIGS. 10A and 10B are flow charts illustrating operation of an agreement facilitator of a profile broker according to one embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

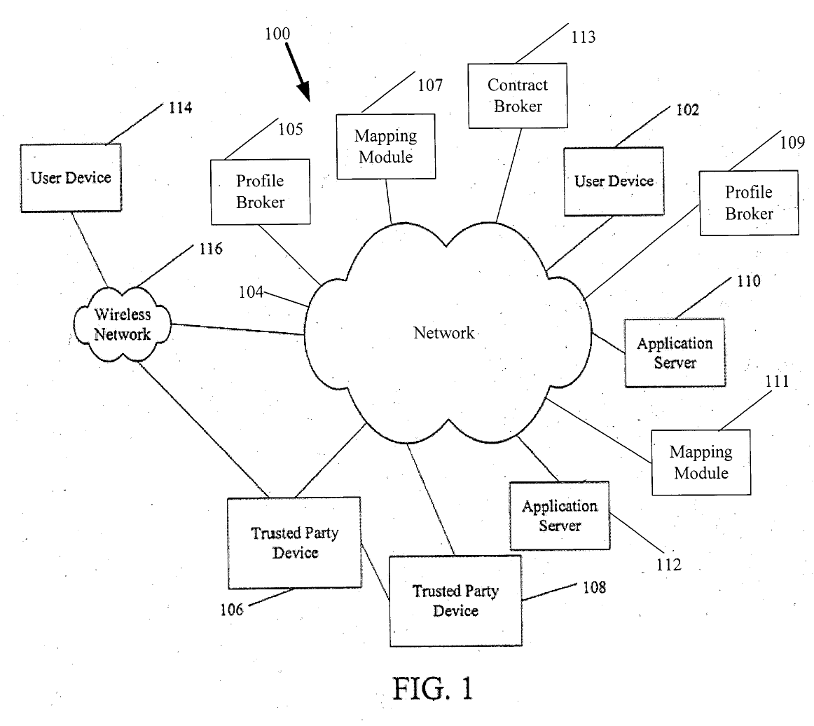

FIG. 1 shows an exemplary embodiment of a system 100 for providing profile information. In this embodiment, one or more user devices, such as user device 102 and/or user device 114, may communicate with a trusted party device, such as trusted party device 106 or trusted party device 108, over a network 104, such as the Internet or other wide area network (WAN). Typically, the user devices are used or otherwise under the control of one or more users that can comprise any of a number of different individuals or entities, such as businesses. The user devices can communicate with such other devices to create, change or delete personal data about the user. The user devices may also indicate which portions of the data may be released and to whom, as well as a time period during which the data may be released. Further, the user devices may also communicate directly with a second party, such as an online merchant or the like, via a second party device, such as application server 110, application server 112, another user device or group of user devices, over the network. Like the user devices, the second party devices are typically used or otherwise under the control of one or more second parties that can comprise any of a number of different individuals or, as is more typical, entities such as businesses. Although the user devices can communicate with the other devices over the network, the user devices may access a second party device directly via a wireless network 116, or indirectly via the wireless network and the network, as shown with respect to user device 114. For example, user device 114 may access trusted party device 106 or trusted party device 108 via the wireless network.

In one embodiment of the invention, each user device, such as user device 102, 114, may be, for example, a mobile subscriber unit, such as a wireless mobile phone, a personal computer, or a Personal Digital Assistant (PDA), all having therein a processor connected to a machine-readable medium, such as, for example, a computer memory, such as a Read Only Memory (ROM), a Random Access Memory (RAM), or a SIM card via a bus, and a means to connect with a computer network, either via, for example, a modem, DSL, cable, wireless modem, or any other well known means of connecting to a network. The ROM may include instructions for the processor as well as static data or constants. The RAM may also include instructions for the processor, static (constants) data and dynamic (variables) data. The user devices may also include other machine-readable media, such as floppy or hard disk drives and associated disks. Each application server 110, 112 and trusted party device 106, 108 may also include a processor, ROM, RAM, or other storage devices, firmware and/or software, as well as a means to connect to a computer network, as described above.

As described below, reference will be made to user device 102, although it should be understood that the same description applies equally to user device 114, as well as other user devices not shown. Similarly, reference will subsequently be made to application server 110, and to trusted party device 106. As with reference to the user device, it should also be understood that the same description can apply to application server 112 or any other similar application server not shown, and trusted party device 108 or any other similar trusted party device not shown, respectively, without departing from the spirit and scope of the present invention.

As explained in more detail below, embodiments of the invention provide a user with a way to control the dissemination of personal data of the user to second parties. In this regard, user device 102 can additionally communicate with one or more profile brokers, such as profile broker 105 or profile broker 109. In turn, the profile brokers can communicate with second party devices (e.g., application server 110, another user device or group of user devices) on behalf of the user device as to the dissemination of personal data and the conditions under which the personal data is disseminated. Although the profile brokers have been shown and described as being a distinct element of the system 100, it should be understood that the profile brokers can be included within any of a number of other elements of the system such as, for example, the user device and/or the trusted party device. It should also be understood that the system need not include profile brokers. In such instances, any of a number of other elements of the system (e.g., the user device and/or the trusted party device) can perform the functions of the profile brokers, as described herein. As before with respect to referencing user device, the application server and the trusted party device, the description below will refer to profile broker 105. It should be understood, however, that the same description can apply to profile broker 109 or any other similar profile broker not shown.

The personal data is stored in a personal data repository which may include a master profile that contains the user's personal information and a service profile that includes profile information pertaining to a particular second party or to a type of second party. The user may create the master profile and service profile, or as explained below, the master profile and the service profile may be created automatically. The master and service profiles may reside in storage on a user's device, in a distributed manner in storage on one or more trusted party devices, or in a distributed manner in storage on one or more trusted party devices and the user device. The user can decide where the master and service profiles are to be stored and may indicate his preferences when registering for service with a trusted party.

As will be appreciated by those skilled in the art, different second parties may have different formats within which such parties store personal data. Such formats may include, for example, the PASSPORT™ format developed by the Microsoft Corporation and/or the Customer Profile Exchange (CPEX) format developed by the Customer Profile Exchange Working Group. The personal data repository may store the user's personal information in a format not compatible with respective second party devices, or otherwise in a format different than that requested by the respective second parties. As such, to provide second party devices with the personal data in a format compatible with, or otherwise desired by, the respective second party devices, the system 100 can include one or more mapping modules, such as mapping module 107 and/or mapping module 111. The mapping modules can communicate with the devices storing the respective master profile and/or service profile (e.g., the user device 102 and/or the trusted party device 106). Each mapping module can receive personal data from the respective devices, format the personal data in compliance with respective second party devices, and thereafter pass the formatted personal data to the respective second party devices (e.g., the application server 110, another user device or group of user devices), also in communication with the respective mapping module.

Like profile broker 105, it should be understood that, although the mapping modules 107, 111 have been shown and described as being a distinct element of the system 100, the mapping modules can be included within any of a number of other elements of the system. For example, the mapping modules can be included within the user device 102, the trusted party device 106 and/or any one or more of the second party devices (e.g., the application server 110, another user device or group of user devices). It should also be understood that the system need not include the mapping modules. In such instances, any of a number of other elements of the system (e.g., the user device and/or the trusted party device) can perform the functions of mapping modules, as described herein. Also, like profile broker, as described below, reference will be made to mapping module 107. But it should be understood that the same description can equally apply to mapping module 111 or any other similar mapping module not shown, without departing from the spirit and scope of the present invention.

To provide one or more contracts governing the use of the user's profile information by the various second parties, the system 100 may further include one or more contract brokers 113. In this regard, the contract broker is capable of communicating with a device requesting a contract, such as the user device 102, the profile broker 105 and/or the trusted party device 106. The contract broker may be capable of providing one or more different contracts. As such, the contract broker can provide different contracts based upon different circumstances, such as different users, different second parties, and different defined terms of the agreement between the respective users and the respective second parties. It will be appreciated that although the contract broker is shown and described as comprising a separate element of the system, the contract broker can be included within one or more of the other elements of the system, such as within the trusted party device. The system need not include a contract broker. In such instances, one or more of the other elements of the system, such as the trusted party device, can perform the functions of the contract broker.

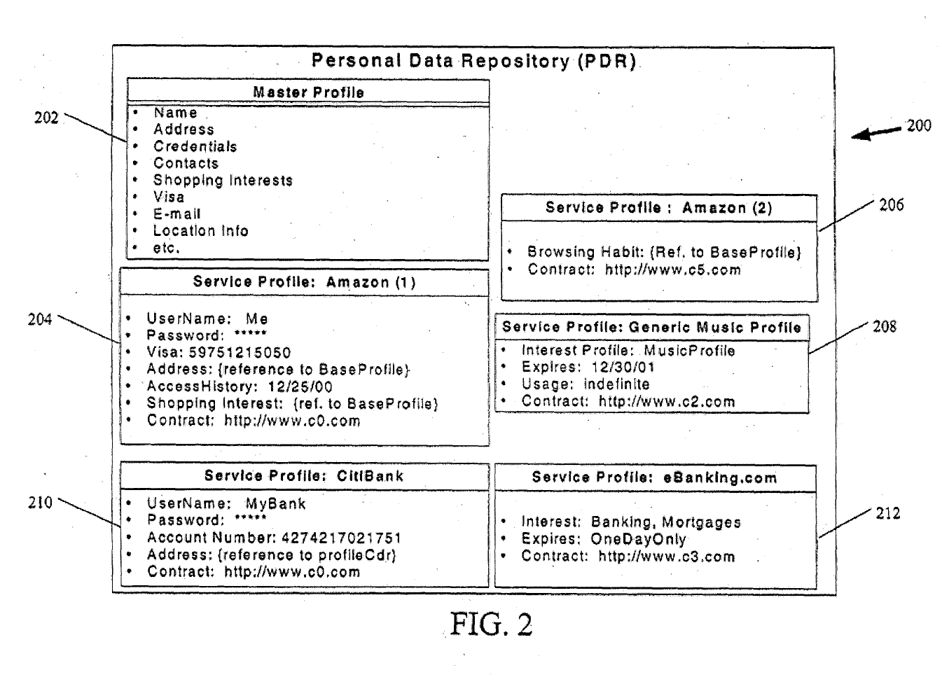

Reference is now drawn to FIG. 2, which shows an exemplary embodiment of a personal data repository 200, which typically includes the personal data of a user. In one embodiment, the personal data of the user may be contained in a master profile 202 and in one or more service profiles, such as service profiles 204, 206, 208, 210 and 212. The master profile may include generic information or specific information about the user or owner of the profile depending upon the kind of information the user is willing to share. The master profile may include such items as name, address, credentials, for example, race, eye color or hair color, contacts, shopping interests, credit card information, e-mail address, location information, etc.

The service profiles 204, 206, 208, 210, 212 may include profile information that the user wants to share with one or more other parties. For example, one service profile may contain profile information that a user wants to share with only one party, such as a bank. Other service profiles may contain information, such as a user's music interests, that the user wants to share with several other parties such as, for example, a music shop or the user's friends. The user defines what can be shared, with whom, when and according to what kind of contract. Service profiles are based on this information.

An example of a number of service profiles is shown in FIG. 2. As shown, then, service profiles 204, 206, 210 and 212 contain information related to a specific service, and service profile 208 pertains to a specific subject (music). In instances in which the service profiles contain information related to a specific service, service providers may typically only access service profiles that pertain to the respective service providers. For example, service profile 204 pertains to Amazon.com and contains information such as a username and password for logging onto the Amazon.com web site, credit card information, a reference or link to a field, such as an address in the master profile, access history showing the last time that the Amazon.com site was accessed, and shopping interests, which may refer to shopping interests stored in the master profile. Service profile 204 also contains information such as a copy of a contract or a reference to a contract (e.g., http://www.c0.com), which describes an agreement between the user and a second party, for example, Amazon.com, the contract describing the conditions under which the second party can access, use and distribute portions of the information in the personal data repository.

The service profiles 204, 206, 208, 210, 212 may also include other types of information, such as an expiration date, indicating when authorization for the second party to access, use and distribute portions of the personal data is no longer granted and an interest profile showing interests such as music or other types of interest such as banking and mortgages. Further, the service profile may include such information as browsing habits, for example, types of sites visited, which can be included within the service profile or a link to the browsing habits can be included in the service profile linking the service profile to browsing habits stored in the master profile. It should be noted that the service profile and the master profile 202 may be stored completely in storage on the user device 102, on the trusted party device 106, or partly on the user device and partly on one or more connected trusted party devices in a distributed manner.

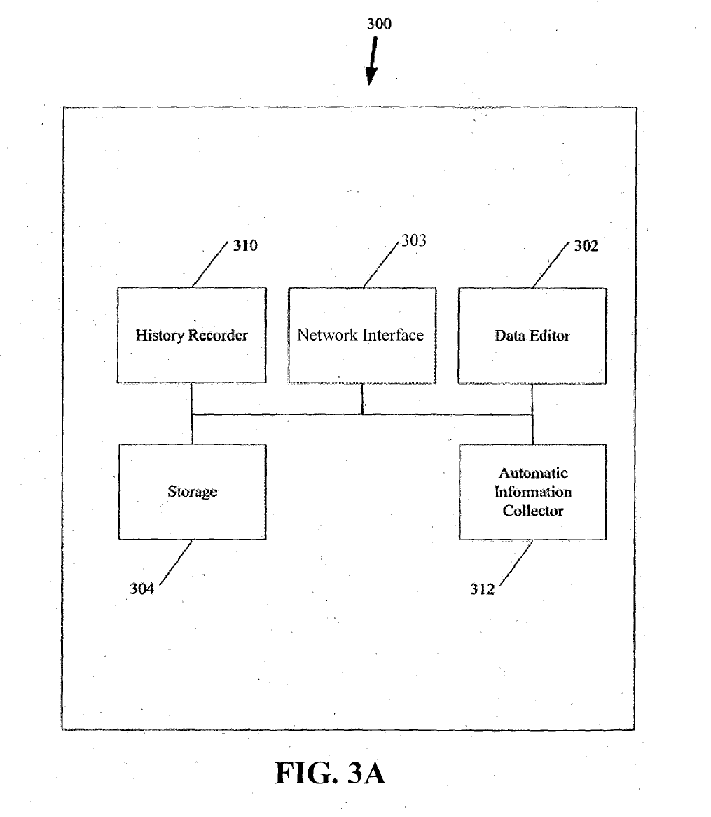

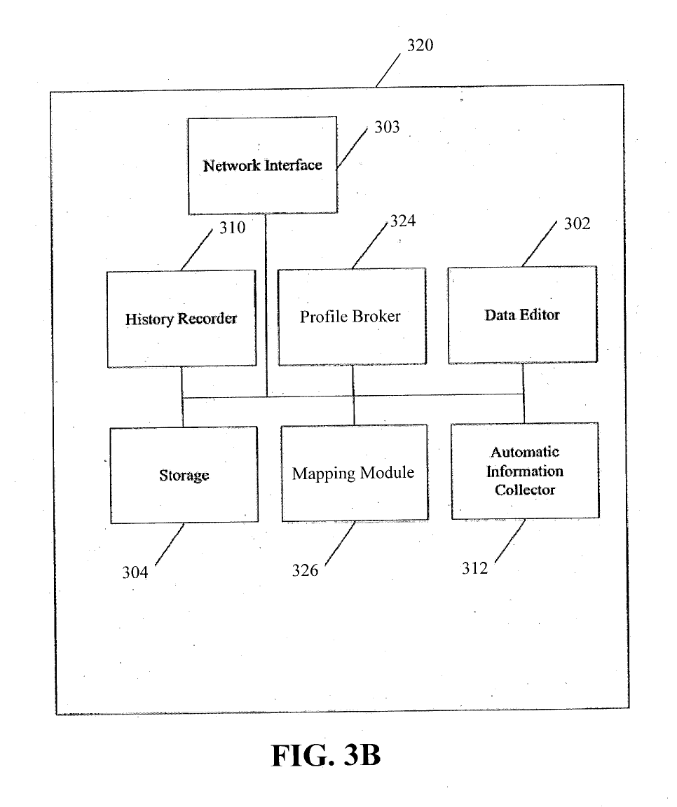

Reference is now drawn to FIG. 3A, which illustrates a functional block diagram of an exemplary embodiment of a trusted party device 300. A trusted party device can comprise any of a number of different devices operated or otherwise under the control of a trusted party, which is typically a second party with a preexisting relationship with the user of the user device. For example, the trusted party may include a telecommunications provider, such as AT&T wireless, Sprint, Sonera, NTT-DoCoMo, and/or Orange. Additionally, or alternatively, the trusted party may include an Internet service provider (ISP), such as America Online (AOL), and/or any other second party, such Nokia and/or Microsoft.

The trusted party device 300 may include a data editor 302, network interface 303, storage 304, a history recorder 310, and an automatic information collector 312. The data editor 302 can provide the trusted party device with an editing function and allow a user communicating with the trusted party device, such as via a user device 102, to enter a new master profile, edit the master profile, indicate which portions of the master profile may be accessed and by whom, enter the times during which the portions of the master profile may be accessed, change portions of the master profile and delete portions of the master profile. Although a service profile can be created automatically based on access and contract rules defined by the user, the user may use the data editor to create and/or edit a service profile as described above. The profiles may reside on the user device and/or on the trusted party device. In an embodiment of the invention, when a user purchases an item from an online store, for example, the user may create the profiles using, for example, an online form. The user may also specify where portions of the profiles are to be stored, for example, the user device and/or one or more trusted devices. The information that is entered may be referenced at a later time, such that basic information need not be retyped.

The storage 304 of the trusted party device 300, as described previously, may include, for example, RAM, a hard disk or a floppy disk, to store portions of the personal data repository. The network interface 303 may provide connectivity with a network and may be connected to a network via cable, DSL connection, modem, wireless modem, bluetooth technology or any other well known means for connecting to a network.

As shown in FIG. 3A, the trusted party device 300 may include a history recorder 310 which can track the actions of the user, such as via the user device 102, and store a history of the actions in a portion of storage associated with the user's master profile. The trusted party device may also include an automatic information collector 312 to capture personal information about the user and automatically create or add to the master profile or a service profile. For a further description of the trusted party device, see U.S. patent application Ser. No. 09/988,002, entitled: Personal Data Repository, filed Nov. 16, 2001, the contents of which are hereby incorporated by reference in its entirety.

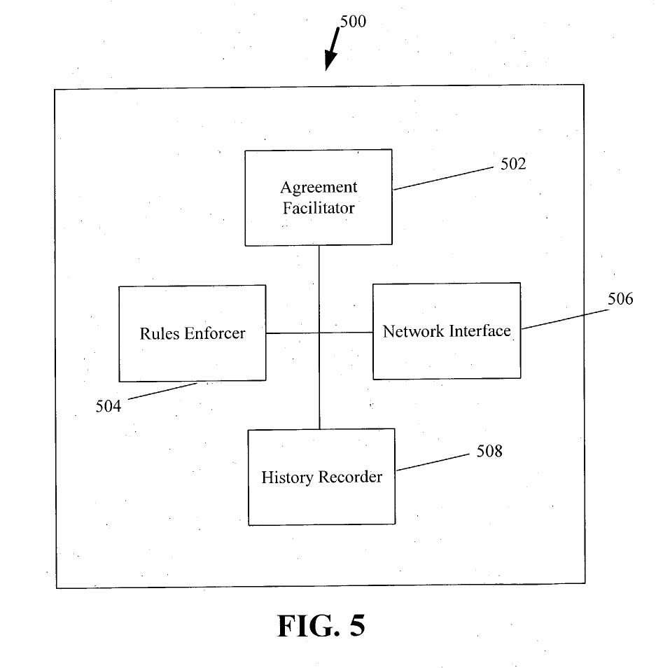

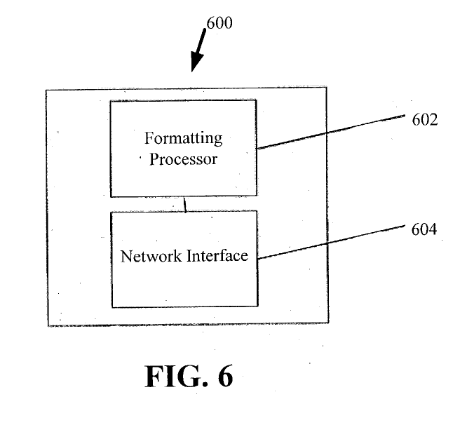

Although one embodiment of the trusted party device has been shown in FIG. 3A and described above, it will be appreciated that many other embodiments of the trusted party device may be included within the system 100 without departing from the spirit and scope of the present invention. For example, FIG. 3B illustrates another embodiment of the trusted party device. More particularly, FIG. 3B illustrates an embodiment of the trusted party device 320 that includes the functions previously described regarding the description of the trusted party device 300 of FIG. 3A. The embodiment of the trusted party device 320 of FIG. 3B differs from that shown in FIG. 3A, however, in that the trusted party device 320 of FIG. 3B also includes the profile broker 324 and the mapping module 326. The profile broker and the mapping module generally function as described above with reference to FIG. 1 and, more particularly, function as described below with reference to FIGS. 5 and 6, respectively. Although the trusted party-device of FIG. 3B includes both the profile broker and the mapping module, it should be understood that the trusted party device can include either the profile broker or the mapping module, without departing from the spirit and scope of the present invention.

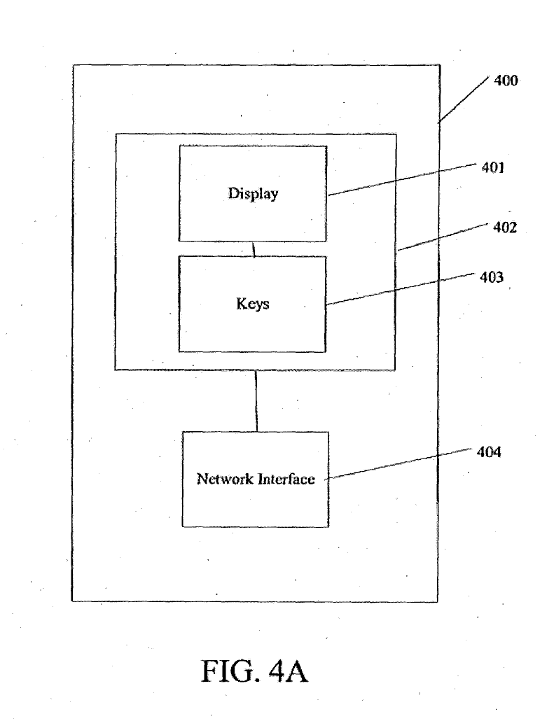

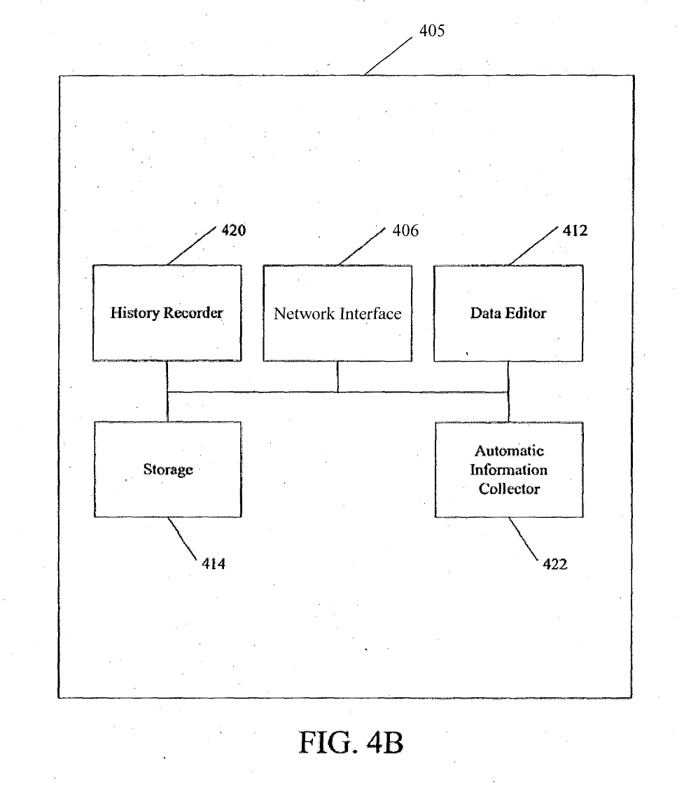

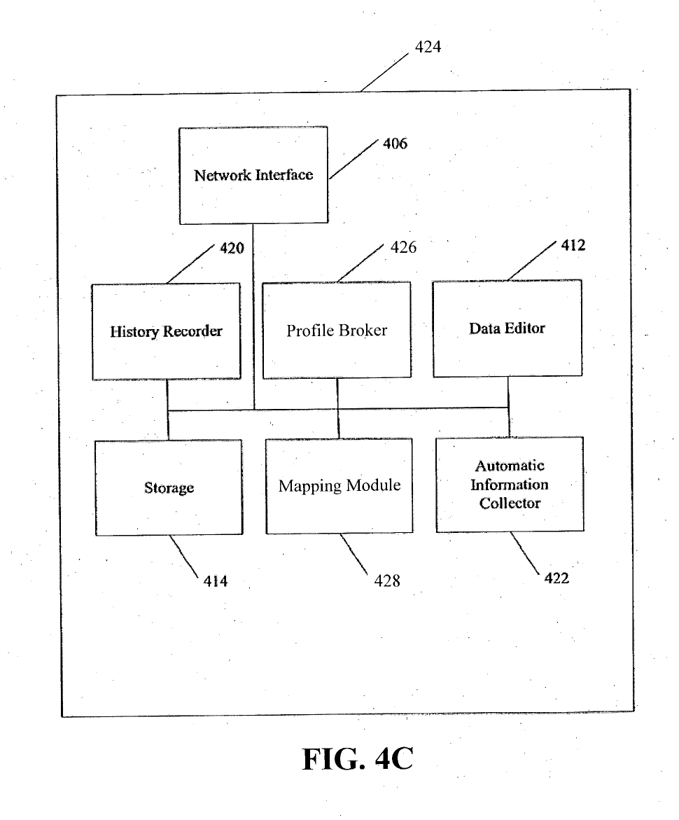

Reference is now drawn to FIG. 4A, which illustrates one embodiment of a user device 400 for communicating with a trusted party device 106, where the trusted party device or a plurality of trusted party devices have storage for storing the user's master profile and service profiles. The user device includes a user interface 402 that may include a display 401 and an input device, such as keys 403 or a keyboard, or a speech recognition device (not shown). The user interface may perform any of a number of different functions but, according to one embodiment, the user interface 402 communicates with data editor 302 of the trusted device via a network interface 404. In this regard, the network interface 404 may be connected to the network 104, such as via cable, DSL connection, modem, wireless modem, bluetooth technology or any other well known means for connecting to a network. The user interface can also receive input via the input device (e.g., keys 403) and send the information to the data editor 302 via the network interface 404. Responses from the trusted party device can be received by the user device 400 via the network interface 404 and can then be displayed to the user via the display 401 of the user interface. For a further description of the user device, see U.S. patent application Ser. No. 09/988,002.

Like the trusted party device 106, it will be appreciated that many embodiments of the user device, in addition to or in lieu of the user device 400 illustrated in FIG. 4A, may be included within the system 100. In this regard, FIG. 4B illustrates another exemplary embodiment of a user device 405. The user device 405 may include a data editor 412, storage 414, a history recorder 420, and an automatic information collector 422. Like the embodiment of FIG. 4A, the user interface also includes a network interface 406, which can provide connectivity with the network, such as via cable, DSL connection, modem, wireless modem, bluetooth technology or any other well known means for connecting to a network. As will be appreciated, the user device of FIG. 4B contains the same functional elements as the trusted party device 300 shown in FIG. 3A. In this regard, the functional elements operate in a manner similar to that described above. In yet another embodiment, shown in FIG. 4C, the user device 424 includes the profile broker 426 and the mapping module 428, which can operate in a manner previously described with reference to FIG. 1, and further described below with reference to FIGS. 5 and 6, respectively.

With reference now to FIG. 5, one embodiment of the profile broker 500 includes an agreement facilitator 502, a rules enforcer 504, a network interface 506, and a history recorder 508. Like before, the network interface 506 provides connectivity with the network 104 and may be connected to a network via cable, DSL connection, modem, wireless modem, bluetooth technology or any other well known means for connecting to a network. Also similar to before, the history recorder 508 can track the actions conducted, and/or transactions entered into, by the profile broker on behalf of the user and store a history of the actions and/or transactions, such as in a portion of storage associated with the user's master profile. The agreement facilitator 502 is provided to aid in negotiating an agreement or contract between a user and a second party regarding the use of personal information (i.e., profile information) of the user that is stored in the personal data repository. A copy of the contract or a link to the copy of the contract may be stored in a service profile (as shown in FIG. 2).

The rules enforcer 504 can enforce the rules corresponding to the agreement between the user and the second party. More particularly, the rules enforcer can enforce the rules such that the second party can only access those portions of the personal data of the user which the user has agreed to make available to the second party for a time period, if any, agreed upon between the user and the second party. The profile broker, including the agreement facilitator and the rules enforcer, can comprise any of a number of different elements, devices, systems or the like capable of performing the functions of the respective elements as described herein. For example, according to one embodiment, the profile broker, agreement facilitator and the rules enforcer can be embodied in one or more processing elements, such as one or more personal computers, other high level processors or the like, that may operate according to instructions, as such may be embodied in a computer software program.

As shown in FIG. 6, one embodiment of a mapping module 600 includes a formatting processor 602 and a network interface 604. The network interface is capable of providing connectivity with the network 104, such as in a manner similar to the network interface 506 of the profile broker 500. The formatting processor allows a second party device to request personal data from the user in a specified format and, all other conditions satisfied (e.g., existing contract), deliver the requested personal data in the specified format. The formatting processor is therefore capable of communicating with a second party device requesting personal data, either directly or indirectly (e.g., through the user device 102 and/or profile broker 105), to receive a specified format for the requested profile information. Likewise, the formatting processor is capable of communicating with the devices storing the respective master profile and/or service profiles (e.g., the user device and/or the trusted party device 106) to receive the requested profile information in a predefined, stored format that may or may not be the same as the specified format. If the stored format differs from the specified format, then, the formatting processor can reformat the requested personal data from the stored format to the specified format. Thereafter, the formatting processor can deliver the requested personal data to the second party device, either directly or indirectly (e.g., through the user device 102 and/or profile broker 105). The mapping module, including the formatting processor, can comprise any of a number of different devices capable of performing the functions of the respective elements as described herein. For example, according to one embodiment, the mapping module and the formatting processor can be embodied in one or more processing elements, such as one or more personal computers, other high level processors or the like, that may operate according to instructions, as such may be embodied in a computer software program.

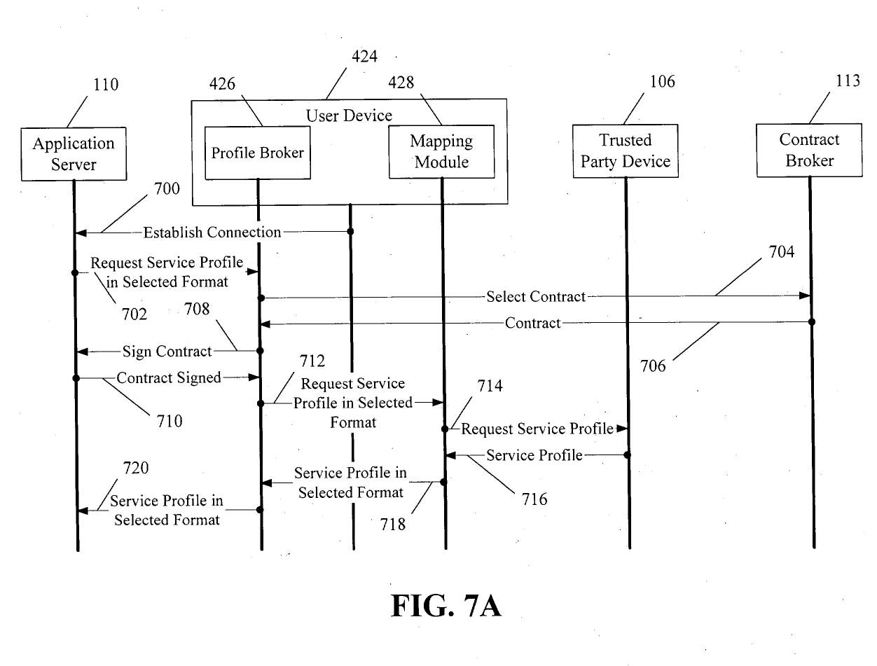

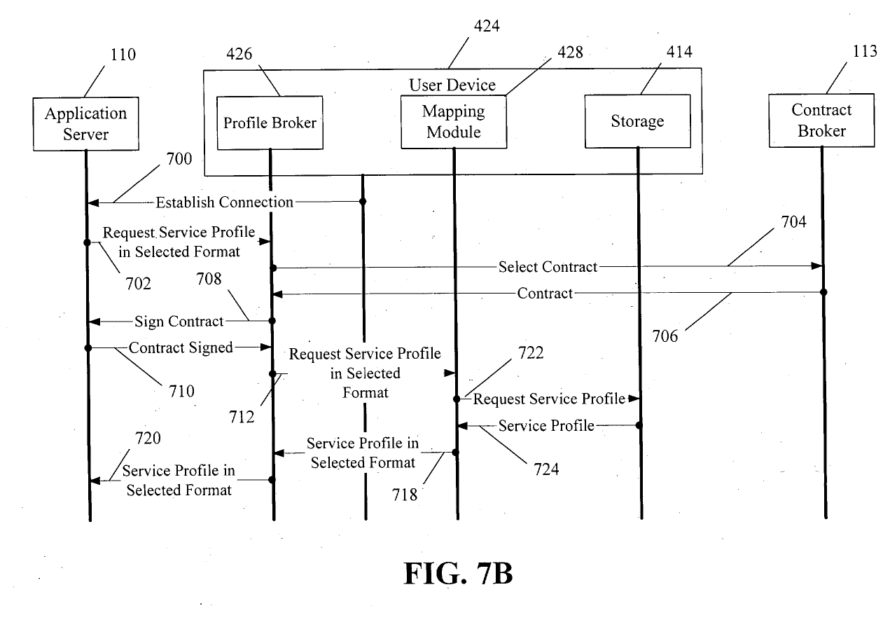

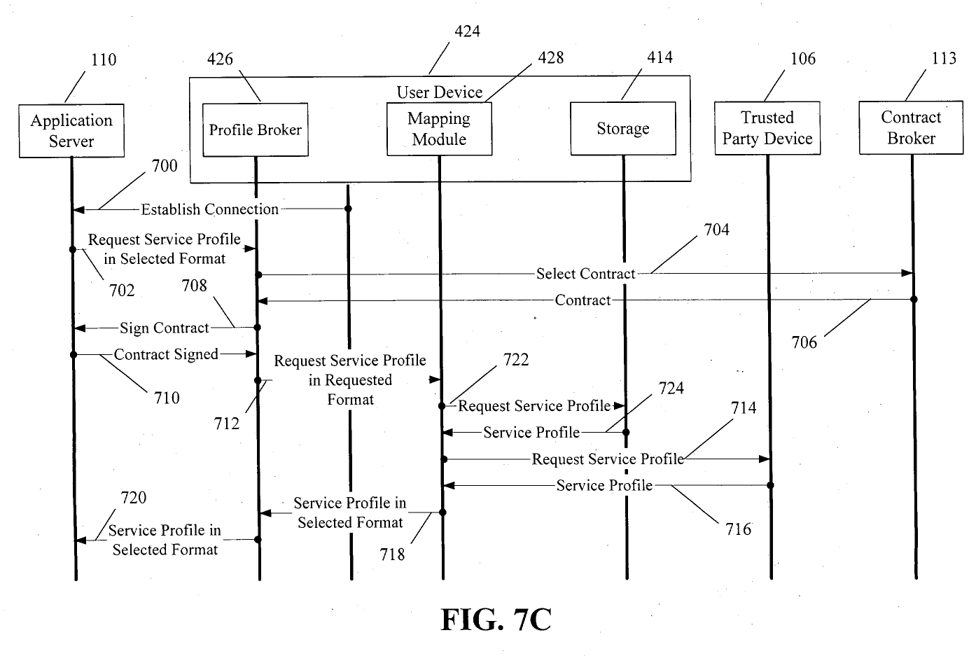

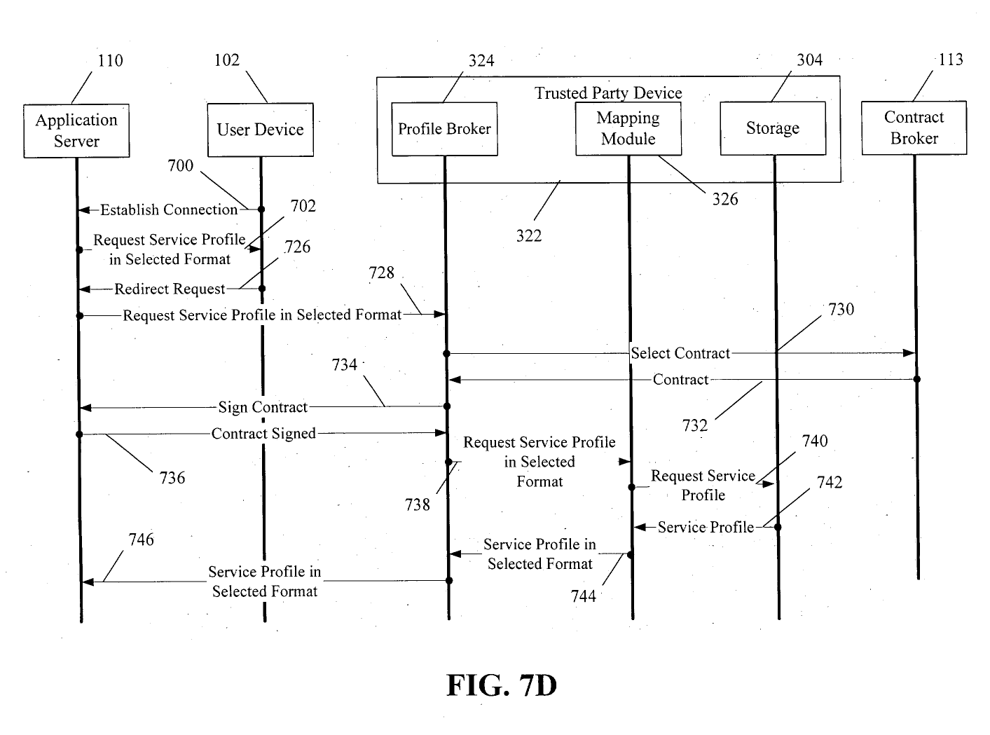

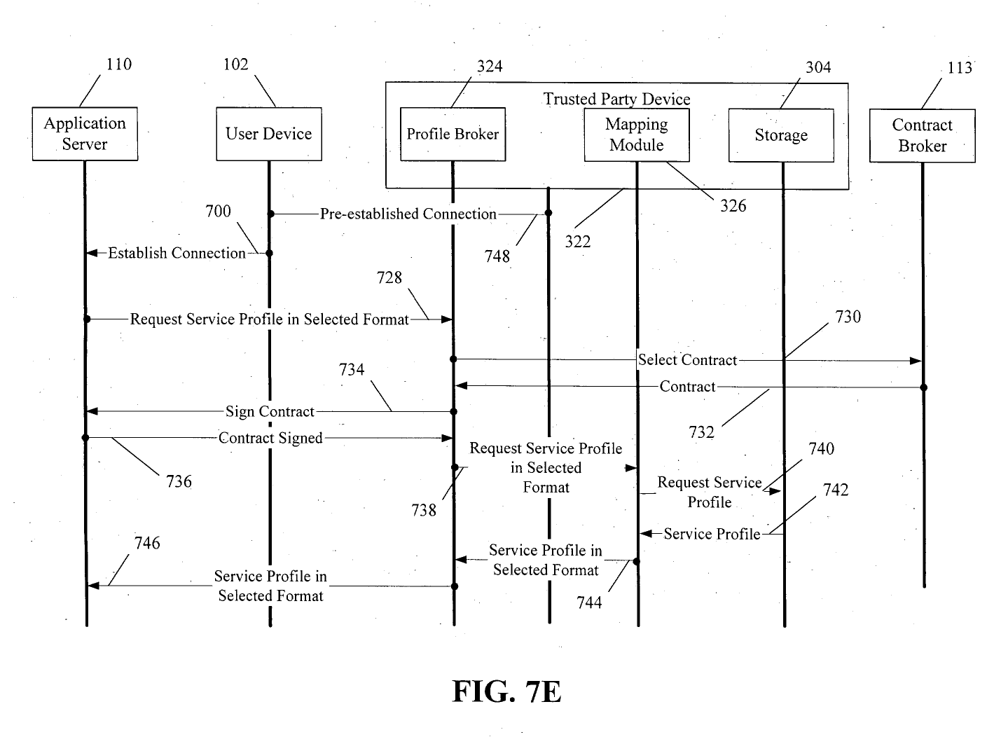

Having described the elements of the system 100, reference will now be made to FIGS. 7A-7E, which illustrate a method of providing profile information according to various embodiments of the present invention. It should be understood, however, that the following embodiments are only representative of a number of embodiments and, as such, should not be taken to limit the present invention.

As shown in FIG. 7A, one embodiment of the method of providing profile information can be implemented with a system, such as system 100, including a second party device, such as application server 110, as well as a user device, such as user device 424 including a profile broker 426 and a mapping module 428 (see FIG. 4C). The system can further include a trusted party device, such as trusted party device 106, and a contract broker 113. According to the embodiment illustrated in FIG. 7A, the method of providing profile information begins with the user device attempting to establish communication, or a connection, with the application server by transmitting a message to the application server, as shown at 700. For example, where the application server comprises a second party's online store web server, a user of the user device may browse through the online store for one or more items to purchase. Upon locating an item, then, the user device may attempt to establish communication with the application server by sending a request to complete an order form for the located item, where the information requested on the order form is included within a service profile of the user.

Upon receipt of the message from the user device 424, the application server 110 responds by sending a request for a service profile to the user device or, more particularly, the profile broker 426, as shown at 702. The request for a service profile can include any of a number of different pieces of information but, in one embodiment, includes at least a description of the service profile requested by the second party, as well as a selected format (e.g., CPEX) in which the second party desires to receive the profile information. Continuing the above example, then, the service profile can include personal information of the user requested by the second party's online store, such as to populate an order form, in order to complete the user's order for the located item.

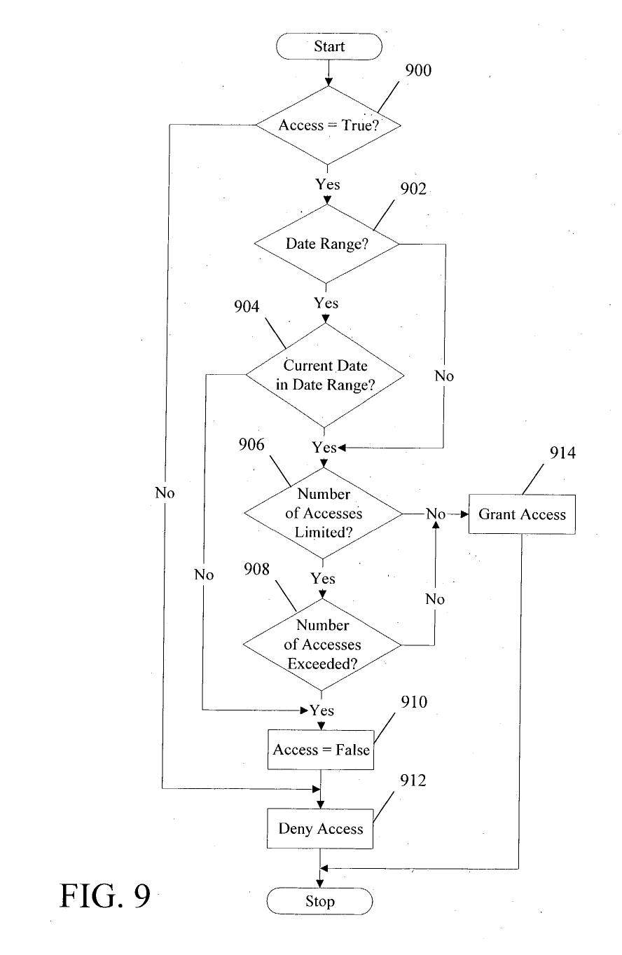

Using the rules enforcer 504 (see FIG. 5) to examine the current rules regarding release of personal information to the particular second party, the profile broker 426 determines whether the second party associated with the application server 110 has permission to receive information in the service profile. If there is no pending contract or agreement with the second party, the rules enforcer denies access to the personal information until an agreement is reached. In such instances, the application server may be prevented from accessing information in the service profile, such as by means of well-known public/private encryption techniques, as well as authentication techniques, such as the use of a password. A more detailed description of the operation of the rules enforcer according to one embodiment of the present invention is explained below with reference to FIG. 9.

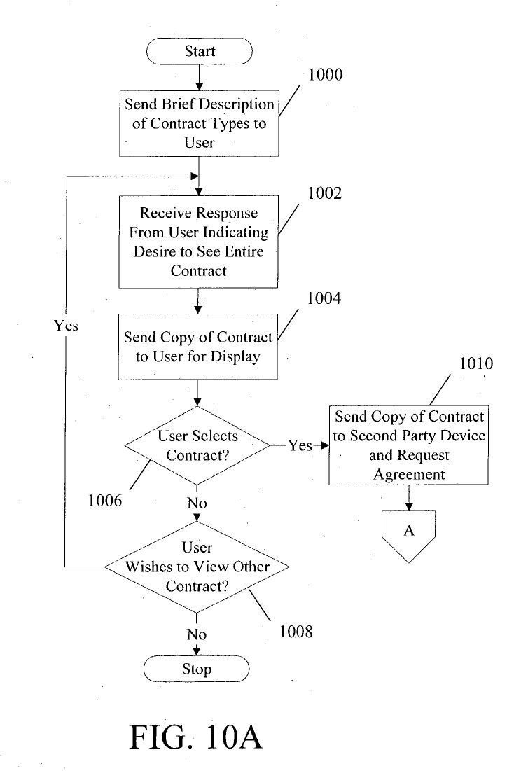

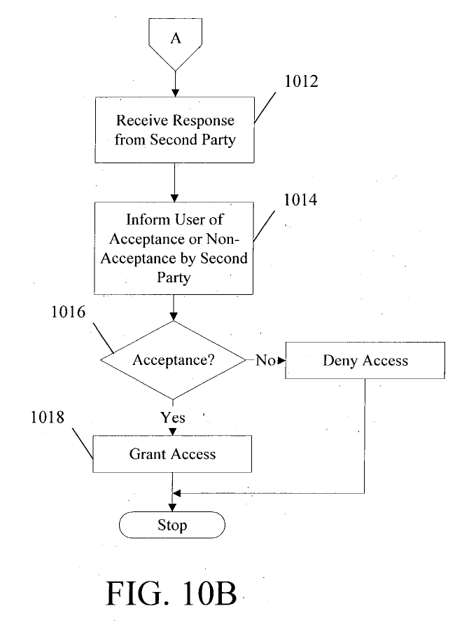

If the second party does not yet have permission, the agreement facilitator 502 of the profile broker 426 can negotiate and thereafter reach an agreement with the second party. In this regard, the profile broker can select a contract, such as from the contract broker 113, as shown at 704. The contract can be selected in any of a number of different manners, such as based upon pre-selected user preferences or based upon a selection of the contract by the user of the user device 424, as described more fully below with reference to FIGS. 10A and 10B. At 706, then, the profile broker 426 can receive the selected contract from the contract broker. After receiving the selected contract, the profile broker can send the contract to the application server 110 along with a request that the second party agree to the contract, as shown at 708.

The contract can be sent or otherwise forwarded to the application server 110 in any of a number of different manners. For example, the contract can be sent to the application server as a document, such as a textual document that includes the contents of the contract. Also, for example, the contract can be sent to the application server as a document formatted with internal tags, such as according to the Extensible Markup Language (XML), where the tags can define separate terms of the contract, as explained more fully below. In another example, the contract can be sent by merely sending a reference to the contract (e.g., http://www.c0.com, as shown in FIG. 2). In such instances, then, the second party can access the contract from the reference.

Upon receiving the contract, if the second party agrees to the terms of the contract, the second party device returns an indication of agreement to the profile broker, as shown at 710. The agreement may be reached in any number of manners. For example, the agreement can be reached by the second party viewing the contract on a display of the application server 110 and indicating approval by selecting, for example, with a pointing device, such as a mouse, a control indicating agreement. The agreement may also be reached by, for example, the application server accepting certain standard agreements pre-approved by the second party. Upon receipt of the indication of agreement, then, the profile broker 426 can store a copy of the contract in, for example, the master profile with a reference to the contract being stored in the service profile.

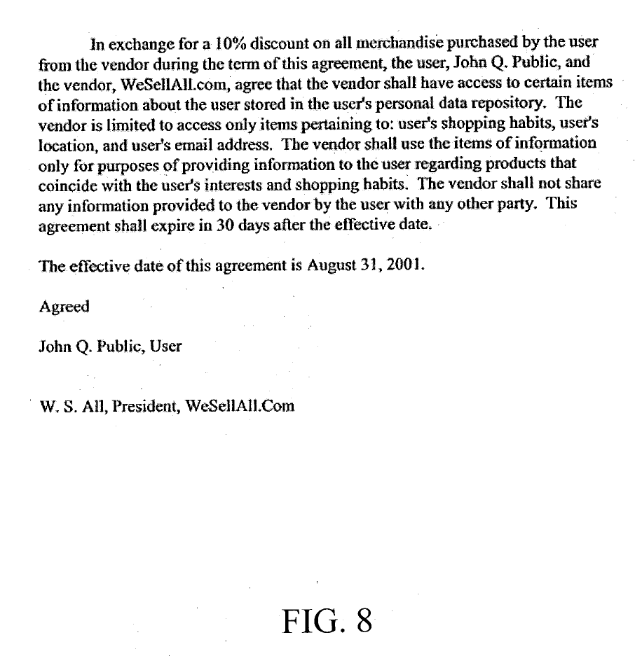

As an example of one type of contract to which the second party may be subject, reference is drawn to FIG. 8. The exemplary agreement is between a user, such as a customer, and a merchant. It should be understood, however, that an agreement could be between a user and a variety of second parties, such as a merchant, another user, or a group of users. In the exemplary agreement between the user and the merchant, the merchant agrees that the user will receive a 10% discount on all merchandise purchased from the merchant during the term of the agreement, i.e., thirty days. In return, the merchant will, have access to the user's personal information regarding the user's shopping habits, location, and email address. The merchant also agrees to use the information provided by the user only for purposes of providing information to the user regarding products that coincide with the user's interests and shopping habits, i.e., targeted advertising. Further, the merchant agrees not to share the information with other parties. As shown, the term of the exemplary agreement is thirty days. Although the consideration to the user in the illustrated embodiment comprises a discount on merchandise, the consideration can be any of a number of different types of consideration such as, for example, rewarding the user with points toward a discount or free gift, providing a monetary award in exchange for access to the user's personal information, or merely completing a request of the user (e.g., fulfilling an order for one or more items).

Although not shown in FIG. 8, the contract may also include whether a second party is permitted to keep a history of actions taken by the user with respect to the second party. Further, the contract may require that, if the second party shares the personal information regarding the user, that the second party inform the user regarding which parties received the shared information and any compensation the second party received for sharing the information. Any other conditions may additionally or alternatively be included in the contract.

Again referring to FIG. 7A, after the profile broker 426 receives the indication of agreement to the contract from the second party, the profile broker sends a request to the mapping module 428 for the service profile in the selected format, as shown at 712. In the illustrated embodiment, the trusted party device 106 stores the service profile, such as within storage 304 (see FIGS. 3A and 3B). In this regard, upon receipt of the request from the profile broker, the mapping module sends a request to the trusted party device for the service profile, as shown at 714. The trusted party device then responds at 716 by transmitting the service profile back to the mapping module. After receiving the service profile, then, the mapping module can reformat the service profile into the selected format, if the service profile is not already in the selected format. Thereafter, the mapping module forwards the service profile in the selected format to the profile broker which, in turn, forwards the service profile to the application server, as shown at 718 and 720.

As indicated above, in the embodiment of FIG. 7A, the trusted party device 106 stores the service profile. As also indicated above with respect to FIG. 4C, the user device 424 may include storage 414 capable of storing the service profile. As such, according to another embodiment of the present invention, shown in FIG. 7B, the service profile requested by the application server 110 is stored in storage 414 by the user device. In this embodiment, the flow of messages between the user device and the application server, and between the user device and the contract broker 113, can occur in a manner similar to that described above with reference to FIG. 7A. In contrast to FIG. 7A, however, upon receiving a request for the service profile in the selected format, the mapping module 428 sends a request for the service profile to storage 414, as shown at 722. Then, at 724, storage 414 sends the service profile back to the mapping module. The mapping module then reformats the service profile, if required. Thereafter, as before, the mapping module passes the service profile in the selected format to the profile broker 426, which forwards the service profile to the application server, as shown at 718 and 720. Again referencing the above example where the application server comprises an online store, the second party can utilize the service profile to populate the order form and, in turn, to fulfill the user's order for the located item.

In another embodiment, illustrated in FIG. 7C, the trusted party device 106 stores a portion of the service profile requested by the second party device, while storage 414 within the user device 424 stores the remaining portion of the service profile. In this embodiment, the flow of messages between the user device and the application server, and between the user device and the contract broker 113, can occur in a manner similar to that described above with reference to FIG. 7A, with the mapping module 428 requesting from the trusted party device the portion of the service profile stored by the trusted party device. In addition, the mapping module sends a request for the remaining portion of the service profile to storage 414, in a manner similar to that shown with reference to FIG. 7B. The mapping module then reformats the entire service profile, if required. Thereafter, as before, the mapping module passes the service profile in the selected format to the profile broker 426, which forwards the service profile to the application server, as shown at 718 and 720.

As described with reference to FIGS. 7A-7C, the user device 424 includes the profile broker 426 and the mapping module 428. As indicated above with reference to FIG. 3C, however, the trusted party device 320 may include the profile broker 324 and the mapping module 326. As such, according to other embodiments of a method of providing profile information, as shown in FIGS. 7D and 7E, the trusted party device 320 includes the profile broker and the mapping module.

Referring now to FIG. 7D, in the illustrated embodiment, the method of providing profile information begins, as before, with the user device 102 attempting to establish communication with the application server 110 by sending a message to the application server, as shown at 700. Upon receipt of the message from the user device 424, the application server responds by sending a request for a service profile in a selected format to the user device. But because the trusted party device 322 includes the profile broker 324, the user device sends a message, i.e., a redirect request, to the application server requesting that the application server send the service profile request to the trusted party device, as shown at 726. In response to the redirect request, the application server sends the request for the service profile to the trusted party device or, more particularly, the profile broker 324, as shown at 728.

Similar to before, using the rules enforcer 504 (see FIG. 5) to examine the current rules regarding release of profile information to the particular second party, the profile broker 324 determines whether the second party associated with the application server 110 has permission to receive information in the service profile. If there is no pending contract or agreement with the second party, the rules enforcer denies access to the personal information until an agreement is reached. If the second party does not yet have permission, the agreement facilitator 502 of the profile broker can select a contract regarding handling of the information in the service profile from the contract broker 113, as shown at 730. At 732, then, the profile broker can receive the selected contract from the contract broker.

After receiving the selected contract from the contract broker 113, the profile broker 324 can send the contract to the application server 110 along with a request that the second party agree to the contract, as shown at 734. If agreeable, the second party device returns an indication of agreement to the profile broker, as shown at 736. Upon receipt of the indication of agreement, the profile broker can store a copy of the contract in, for example, the master profile with a reference to the contract being stored in the service profile.

After the profile broker 324 receives the indication of agreement to the contract from the second party, the profile broker sends a request to the mapping module 326 for the service profile in the selected format, as shown at 738. In the illustrated embodiment, the trusted party device 322 stores the service profile within storage 304. In this regard, upon receipt of the request from the profile broker, the mapping module sends a request to storage 304 for the service profile, as shown at 740. Then, at 742, the service profile is transmitted from storage 304 to the mapping module. After receiving the service profile, then, the mapping module can reformat the service profile into the selected format, if required. Thereafter, the mapping module forwards the service profile in the selected format to the profile broker which, in turn, forwards the service profile to the application server 110, as shown at 744 and 746.

In yet another embodiment, shown in FIG. 7E, the user device 102 and the trusted party device 322 have a pre-established connection, shown at 748. In this regard, the pre-established connection allows the user device to automatically forward, or push, various messages received by the user device to the trusted party device. Thus, the method according to the embodiment of FIG. 7E begins, as the embodiment of FIG. 7D, with the user device attempting to establish communication with the application server 110. And like before, the application server sends a request for a service profile back to the user device. Unlike the embodiment of FIG. 7D, however, the user device automatically forwards the service profile request to the trusted party device or, more particularly, the profile broker 324 of the trusted party device. As such, in the embodiment of FIG. 7E, the user device need not request that the application server redirect the request to the trusted party device, and the application server need not resend the request for the service profile. After the profile broker receives the request for the service profile from the application server, the method according to FIG. 7E can proceed as described above with reference to FIG. 7D.

Reference is now made to FIG. 9, which illustrates operation of the rules enforcer 504 of the profile broker 500 according to one embodiment of the present invention. As shown in block 900, upon receipt of a request for a service profile by the profile broker, the rules enforcer checks to determine whether the second party, who operates the second party device, has been granted access to the requested profile information. If access has not been granted, access is denied, as shown in block 912. At this point, the rules enforcer can send notification to the agreement facilitator 502 such that the agreement facilitator can establish an agreement, or contract, between the user and the second party. Additionally, the rules enforcer can maintain a list of second parties with whom the user will not grant access to the profile information, with or without a contract. In such embodiments, if the second party is on the list of second parties with whom the user will not grant access, the rules enforcer can deny access to the profile information, and indicate such denial to the second party without subsequently sending the notification to the agreement facilitator.

If access has been granted, the rules enforcer next determines whether a date range applies to the granted access, as shown in block 902. The date range identifies the period of time during which a respective second party may be granted access. If a date range does apply, the rules enforcer 504 determines whether the current date is within the date range, as shown in block 904. If not, the rules enforcer does not grant access to the information, and the second party is denied access to the information, as shown in blocks 910 and 912. In such instances, the rules enforcer can send notification to the agreement facilitator 502 such that the agreement facilitator can establish a new agreement, or contract, between the user and the second party. If the current date is within the date range or if a date range does not apply, however, the rules enforcer next determines whether the number of accesses by the second party is limited, as illustrated in block 906. If the number of accesses is not limited, the rules enforcer grants access to the information, as shown in 914. Thereafter, the profile broker can request the service profile from the mapping module 107, as previously described.

If the number of accesses is limited, the rules enforcer 504 determines whether the number of accesses has been exceeded. If the number of accesses has been exceeded, the rules enforcer does not grant access to the information, and the second party is denied access to the information, as shown in blocks 910 and 912. As before, in such instances the rules enforcer can send notification to the agreement facilitator 502 such that the agreement facilitator can establish a new agreement, or contract, between the user and the second party. If the number of accesses has not been exceeded, however, the rules enforcer grants access to the information, as illustrated in block 914. After the rules enforcer has granted access, as before, the profile broker can request the service profile from the mapping module.

Referring now to FIGS. 10A and 10B, according to one embodiment of the present invention, operation of the agreement facilitator 502 of the profile broker 500 begins with a brief description of contract types being sent to the user's display on the user device 102, as shown in block 1000. The contract types can be sent to the user's display from any of a number of different locations, but in one embodiment where the contracts are located at the contract broker 113, the contract types are sent from the contract broker to the user's display. The contract types may include, for example, a one-time use contract (for one-time use of user information), a time limited contract (for a time limited use of user information), and an unlimited time period contract (for a time period with no specific ending date). In addition to the time frame, the contracts generally include a number of other terms including terms governing the use and any further distribution of the user's information by the second party. As such, the system and, more particularly, the contract broker can provide a number of standardized contracts. In addition, the contract broker can permit each user to define one or more user-specific contracts that are customized for certain situations that the respective user anticipates. In such instances, each user can define one or more user-specific contracts by specifying all of the terms of the user-specific contracts. Additionally, or alternatively, each user can define one or more user-specific contracts by modifying one or more terms of one or more standard contracts from the contract broker.

After the user indicates a desired contract type, the user's selection is received, as shown in block 1002. A copy of the desired contract may then be retrieved, such as from the contract broker 113, and can be sent to the display of the user device, as illustrated in block 1004. As shown in block 1006, then, the agreement facilitator 502 can determine whether the user selected a contract. If the user did not select a contract, the agreement facilitator can determine whether the user wishes to view another contract, as illustrated in block 1008. If the user does wish to view another contract, the method repeats with the user selecting another contract from the contract types, as shown in block 1002.

If the user did select a contract, a copy of the contract is sent to the second party device, as shown in block 1010. After sending a copy of the contract, a response is received from the second party, as illustrated in block 1012 of FIG. 10B. At this point, the user can be informed of the second party's acceptance or non-acceptance of the contract, such as via the display on the user's device, as shown in block 1014. Upon receiving the response, the agreement facilitator 502 can determine whether the second party accepted the contract, as shown in block 1016. If the contract was accepted, the agreement facilitator may inform the rules enforcer 504 to grant the second party access to the requested profile information, as shown in block 1018. If the contract was not accepted, however, the second party the agreement facilitator can inform the rules enforcer to not grant the second party such access, as shown in block 1020.

If the contract was not accepted, the agreement facilitator 502 may continue to negotiate a contract with the second party, such as by receiving a modified contract from the second party that includes one or more terms that differ from the contract sent to the second party device. As such, one or more terms of the contract may include identifiers, or tags, such that those terms can be easily distinguished from other terms or portions of the contract. For example, a contract may include identifiers that identify terms such as those that define the purpose of use of the profile information by the second party, retention and sharing of the profile information by the second party, and expiration of the contract. By separately identifying different terms, a second party who does not accept the contract can modify one or more terms to make the contract acceptable to the second party.

The modified contract can then be sent back to the agreement facilitator, who can then allow the user to view the modified contract and either accept or reject the modified contract. Alternatively, by including the identifiers, the user can preconfigure rules regarding the negotiation of contracts. In such instances, the agreement facilitator can automatically negotiate the contract in accordance with the preconfigured rules. In either event, if the modified contract is accepted by the user, the process of providing the profile information continues as though the second party accepted the contract, with use of the profile information being under the terms of the modified contact. If the modified contract is not accepted by the user, the negotiation process can continue, such as by the user modifying the modified contract and sending the second modified contract to the second party. Alternatively, if the user does not accept the modified contract, the agreement facilitator can inform the rules enforcer to not grant the second party such access, as before.

In various advantageous embodiments, portions of the system and method of the present invention include a computer program product. The computer program product includes a computer-readable storage medium, such as the non-volatile storage medium, and computer-readable program code portions, such as a series of computer instructions, embodied in the computer-readable storage medium. Typically, the computer program is stored and executed by a processing unit or a related memory device, such as user devices 102 and/or 114, profile brokers 105 and/or 109, trusted party devices 106 and/or 108, mapping modules 107 and/or 111, and/or application servers 110 and/or 112, as depicted in FIG. 1.

Therefore, embodiments of the present invention provide users with control over dissemination and use of personal, profile information. To provide such control according to embodiments of the present invention, second parties who request such personal information are required to agree to a contract that specifies, for example, access and use, by the second party, of any portions of the personal information. In addition, embodiments of the present invention facilitate use of profile information by second parties by providing the accessed personal information in a format specified by the second party, such as a format capable of being stored and utilized by a second party device operated by the second party.

In this regard, FIGS. 1-10 are block diagrams, flowcharts and control flow illustrations of methods, systems and program products according to the invention. It will be understood that each block or step of the block diagrams, flowcharts and control flow illustrations, and combinations of blocks in the block diagrams, flowcharts and control flow illustrations, can be implemented by computer program instructions. These computer program instructions may be loaded onto a computer or other programmable apparatus to produce a machine, such that the instructions which execute on the computer or other programmable apparatus create means for implementing the functions specified in the block diagram, flowchart or control flow block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagrams, flowcharts or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagrams, flowcharts or control flow illustrations support combinations of means for performing the specified functions, combinations of steps for performing the specified functions and program instruction means for performing the specified functions. It will also be understood that each block or step of the block diagrams, flowcharts or control flow illustrations, and combinations of blocks or steps in the block diagrams, flowcharts or control flow illustrations, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method of providing profile information comprising:
receiving a request for profile information from a second party, where the request includes a selected format;
determining whether the second party has access to the profile information, and if the second party does not have access, entering into an agreement to thereby grant access to the second party, wherein entering into the agreement comprises:
forwarding a contract to the second party, wherein the contract specifies at least an allowable use of the profile information; and
receiving from the second party an indication of agreement to the contract; and
transferring the profile information to the second party in the selected format.

2. A method according to claim 1, wherein entering into an agreement includes negotiating an agreement with the second party and thereafter entering into the agreement.

3. A method according to claim 1 further comprising:
receiving the profile information from storage, wherein the profile information is received in a predefined format; and
reformatting the profile information into the selected format when the predefined format differs from the selected format, wherein receiving and reformatting the profile information occur before transferring the profile information.

4. A method according to claim 1 further comprising storing the profile information on a device operated by the user before transferring the profile information.

5. A method according to claim 1 further comprising storing the profile information on a trusted party device before transferring the profile information.

6. A method according to claim 1 further comprising storing a portion of the profile information on a device operated by the user and a remaining portion of the profile information on at least one trusted party device.

7. A method according to claim 1, wherein entering into the agreement further comprises choosing a contract before forwarding the contract.

8. A method according to claim 1 further comprising:
indicating which portions of personal data stored in a personal data repository are releasable to the second party, wherein the profile information comprises those portions that are releasable to the second party.

9. A method according to claim 8 further comprising defining a service profile that includes the profile information and at least one allowable use of the profile information by the second party.

10. A method according to claim 9, wherein defining the service profile comprises defining the service profile to further include a date and a time that at least a portion of the profile information within the service profile was transferred to the second party, and further identifies the second party to whom the stored information was transferred.

11. A method according to claim 9, wherein defining the service profile comprises defining the service profile to further include a description of the contract.

12. A method according to claim 1, wherein receiving a request comprises receiving a request at a device operated by the user, and wherein the method further comprises:
redirecting the request to a trusted party that acts as an agent of the user, wherein determining whether the second party has access to the profile information, entering into the agreement and transferring the profile information are performed by the trusted party.

13. A system for providing profile information comprising:
a user device capable of receiving a request for profile information from a second party, where the request includes a selected format;
a profile broker in communication with the user device, wherein the profile broker is capable of determining whether the second-party has access to the profile information, and if the second party does not have access, entering into an agreement to thereby grant access to the second party, wherein the, profile broker is capable of entering into the agreement by forwarding a contract to the second party and thereafter receiving from the second party an indication of agreement to the contract, wherein the contract specifies at least an allowable use of the profile information, and wherein the profile broker is further capable of transferring the profile information to the second party in the selected format.

14. A system according to claim 13 further comprising a mapping module in communication with the profile broker, wherein the mapping module is capable of receiving the profile information in a predefined format, and thereafter reformatting the profile information into the selected format when the predefined format differs from the selected format.

15. A system according to claim 14, wherein the profile broker and the mapping module are embodied within the user device.

16. A system according to claim 13, wherein the profile broker comprises:
a rules enforcer capable of determining whether the second party has access to the profile information; and
an agreement facilitator capable of entering into an agreement to thereby grant access to the second party when the second party does not have access, wherein the agreement facilitator is capable of entering into the agreement by forwarding a contract to the second party and thereafter receiving from the second party an indication of agreement to the contract, wherein the contract specifies at least an allowable use of the profile information.

17. A system according to claim 16, wherein the profile broker further includes a history recorder capable of recording a history of at least one of actions performed by the profile broker and agreements entered into by the profile broker.

18. A system according to claim 13, wherein the user device further comprises storage capable of storing the profile information.

19. A system according to claim 13 further comprising a trusted party device capable of storing the profile information.

20. A system according to claim 13 further comprising a trusted party device capable of storing a portion of the profile information, wherein the user device includes storage capable of storing a remaining portion of the profile information.

21. A system according to claim 13 further comprising a contract broker capable of providing at least one contract to at least one of the user device, the profile broker, and the second party.

22. A system according to claim 13, wherein the user device is capable of receiving an indication of which portions of personal data stored in a personal data repository are releasable to the second party, wherein the profile information comprises those portions that are releasable to the second party.

23. A system according to claim 22, wherein the user device is further capable of defining a service profile that includes the profile information and at least one at least an allowable use of the profile information by the second party.

24. A system according to claim 23, wherein the service profile further includes a date and a time that at least a portion of the profile information within the service profile was transferred to the second party, and further identifies the second party to whom the stored information was transferred.

25. A system according to claim 23, wherein the service profile further includes a description of the contract.

26. A system according to claim 13, wherein the user device is capable of receiving a request and thereafter transmitting a redirect request to the second party, and wherein the system further comprises:
a trusted party device that includes the profile broker, wherein the trusted party device capable of receiving a redirected request from the second party such that the profile broker can determine whether the second party has access to the profile information, enter into the agreement and transfer the profile information.

27. A system according to claim 26, wherein the trusted party device further comprises a mapping module in communication with the profile broker, wherein the mapping module is capable of receiving the profile information in a predefined format, and thereafter reformatting the profile information into the selected format when the predefined format differs from the selected format.

28. A computer program product for providing profile information, the computer program product comprising a computer-readable storage medium having computer-readable program code portions stored therein, the computer-readable program code portions comprising: comprising:
a first executable portion for receiving a request for profile information from a second party, where the request includes a selected format;
a second executable portion for determining whether the second party has access to the profile information, and if the second party does not have access, entering into an agreement to thereby grant access to the second party, wherein the second executable portion is capable of entering into the agreement by:
forwarding a contract to the second party, wherein the contract specifies at least an allowable use of the profile information; and
receiving from the second party an indication of agreement to the contract; and
a third executable portion for transferring the profile information to the second party in the selected format.

29. A computer program product according to claim 28 further comprising:
a fourth executable portion for receiving the profile information in a predefined format; and
a fifth executable portion for reformatting the profile information into the selected format when the predefined format differs from the selected format, wherein receiving and reformatting the profile information occur before transferring the profile information.
